(19) United States
(12) Patent Application Publication
(10) Pub. No.: US 2024/0382903 A1
(43) Pub. Date: Nov. 21, 2024

(54) REPLACEABLE MEMBRANE DISTILLATION MODULE AND MEMBRANE DISTILLATION PLATE THEREOF

(71) Applicant: ALLIED SUPREME CORP., Taipei City (TW)

(72) Inventors: Roger CHANG, Changhua County (TW); Po-Chun SHIH, Changhua County (TW); Hong-Yi WANG, Changhua County (TW); Ting Yun WU, Changhua County (TW)

(21) Appl. No.: 18/533,890

(22) Filed: Dec. 8, 2023

(30) Foreign Application Priority Data
May 19, 2023 (TW) 112118671

(51) Int. Cl. B01D 61/36; B01D 69/02

(52) U.S. Cl. CPC B01D 61/366; B01D 61/3641; B01D 69/02; B01D 2313/08; B01D 2313/14; B01D 2313/54; B01D 2325/02834; B01D 2325/04

(57) ABSTRACT

A replaceable membrane distillation module has a membrane distillation plate with an upper portion and a lower portion at two ends respectively. Two upper holes and two lower holes are defined through the upper portion and the lower portion at two ends respectively. A distillation portion is recessed in at least one side of the membrane distillation plate, and a distillation membrane covers on the distillation portion that a distillation space forms between the distillation portions and the distillation membrane. Multiple channels are disposed in the membrane distillation plate to communicate one of the upper holes, the distillation space and one of the lower flow holes. A blocking element is selectively combined with one of the upper holes or one of the lower flow holes.

### FIELD OF INVENTION

The present invention relates to a membrane module for distillation, especially a replaceable membrane distillation module.

### BACKGROUND OF THE INVENTION

With the rise of environmental awareness in recent years, the development of industry and technology not only pursues on an economic growth, but also focuses on a concept of environmental conservation and sustainable resource. With a necessity of water used for industry and life living, preventing water pollution and reusing water sources become a major concern in global.

Polytetrafluoroethene (PTFE) has advantages such as anti-stick, chemical resistance, heat resistance, low coefficient of friction and UV resistance, etc., the PTFE is always used as a material for a membrane distillation in current membrane distillation system, and is applied to purify a solution.

However, as a type of the solution and a purification requirement for different fields such as industrial water and domestic water. The membrane distillation systems are needed to be designed in different conditions to fit the different fields (requirements). It makes the membrane distillation system not only hard to be standardized during production, but also leads to incompatibility between each condition of membrane distillation system. And users also need to purchase multiple condition of membrane distillation distillation systems based on their multiple requirements. In addition, when an element/device is damaged or polluted after long-term use, it always causing a high-cost burden and a waste of material resources by directly replaces the entire membrane distillation system as an only solution.

### SUMMARY OF THE INVENTION

In order to overcome the above-mentioned problems that the membrane distillation system is hard to be standardized, and thin film device is not replaceable when an element/device is damaged or polluted, and the membrane distillation systems cannot be used interchangeably.

The present invention provides a membrane distillation plate comprising: a base plate comprising two ends, an upper portion being adjacent to one of the two ends of the base plate, a lower portion being adjacent to the other end of the base plate, two upper holes spaced from each other and defined through the upper portion, and two lower holes are spaced from each other and defined through the lower portion; a distillation portion recessed in at least one side of the base plate, located between the upper portion and the lower portion, and separated from the upper holes and the lower holes; an upper channel disposed in the baes plate, wherein two ends of the upper channel are respectively connected to one of the upper holes and the distillation portion; a lower channel disposed in the baes plate, wherein two ends of the lower channel are respectively connected to one of the lower holes and the distillation portion.

Wherein a blocking element is selectively combined with one of the upper holes or the lower holes.

Wherein a guiding portion is disposed at the distillation portion.

Wherein at least one distillation membrane covers the distillation portion, a distillation space formed between the distillation membrane and the distillation portion.

The present invention also provides a replaceable membrane distillation module comprising: at least two membrane distillation plates stacking to each other, two upper fluid channels and two lower fluid channels defined when each adjacent upper hole and each adjacent the lower hole are connected to each other.

Wherein a blocking element blocks one of the upper fluid channels or one of the lower fluid channels selectively.

Wherein the blocking element is combined with one the upper hole in one of the at least two membrane distillation plates which is aligned with the upper hole connected to the upper channel in an adjacent membrane distillation plate.

Wherein the blocking element is combined with one the lower hole in one of the at least one membrane distillation plates which is aligned with the lower hole connected to the lower channel in an adjacent membrane distillation plate.

### BRIEF DESCRIPTION OF THE DRAWINGS

FIG. 1 is an exploded perspective view of a first embodiment of a membrane distillation plate in accordance with the present invention;

FIG. 2A is a perspective view of the membrane distillation plate in FIG. 1;

FIG. 2B is a perspective view of a second preferred embodiment of a membrane distillation plate in accordance with the present invention;

FIG. 2C is a perspective view of a third preferred embodiment of a membrane distillation plate in accordance with the present invention;

FIG. 3A is an exploded perspective view of a first arrangement preferred embodiment of a membrane distillation module in accordance with the present invention;

FIG. 3B is one of the fluid path diagram of the membrane distillation module in FIG. 3A;

FIG. 3C is another fluid path diagram of membrane distillation module in FIG. 3A;

FIG. 4A is an exploded perspective view of a second arrangement preferred embodiment of a membrane distillation module in accordance with the present invention;

FIG. 4B is one of the fluid path diagram of the membrane distillation module in FIG. 4A;

FIG. 4C is another fluid path diagram of the membrane distillation module in FIG. 4A;

FIG. 5 is a block diagram of a preferred embodiment of a system in accordance with the present invention.

FIG. 6 is another exploded perspective view of a membrane distillation plate in accordance with the present invention;

### DETAILED DESCRIPTION OF THE PREFERRED EMBODIMENTS

In order to make purposes, technical solutions, and advantages of the present invention to be clearer, the following content provides some preferred embodiments in accordance with the present invention.

The present invention provides a replaceable membrane distillation module which can be applied in a membrane distillation system to purify a fluid such as seawater, domestic wastewater or industrial wastewater.

Said membrane distillation is a technology that applies two different temperatures at two sides of a hydrophobic membrane with multiple microporous thereon to make a temperature difference and generate a vapor pressure difference to two liquids at two sides of a hydrophobic membrane. With the vapor pressure difference, a vapor molecule form at one side of the membrane with high temperature is driven to be diffused through the micropores to the other side of the membrane with low temperature, then the vapor molecule be collected after condensed at the other side of the membrane.

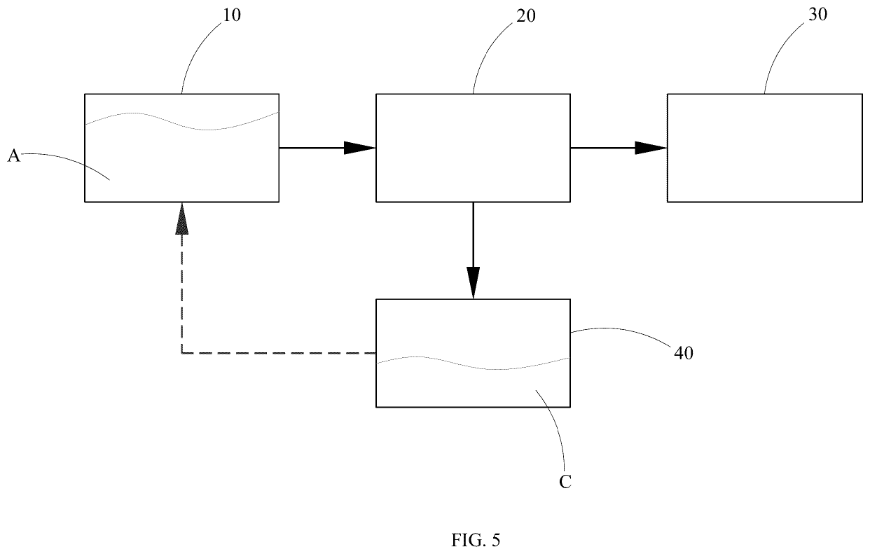

With reference to FIG. 5, the membrane distillation system in accordance with the present invention comprises an influent tank 10, a purification equipment 20, a disposed tank 30, and a purified tank 40. The influent tank 10 receives a fluid A waiting to be purified, and inputs the fluid A to the purification equipment 20 that the fluid A may go a membrane distillation process in the purification equipment 20. Furthermore, the number of times that the fluid A undergoes the membrane distillation process is not limited. For example, after the fluid A be purified, a purified fluid C is formed and is sent to the purified tank 40, the purified fluid C can be sent to the solution tank 10 again and then going the membrane distillation process again in the purification equipment 20 to achieve a cycling membrane distillation procedure.

The purification equipment 20 communicate to the disposed tank 30 and the purified tank 40 respectively. After the fluid A undergoes the membrane distillation process in the purification equipment 20 and be isolated to become a waste fluid and the purified fluid C, the waste fluid then be sent to the disposed tank 30 and the purified fluid C be sent to the purified tank 40. Thus, the waste fluid can be further processed or discarded as a waste, and the purified fluid C can be reused.

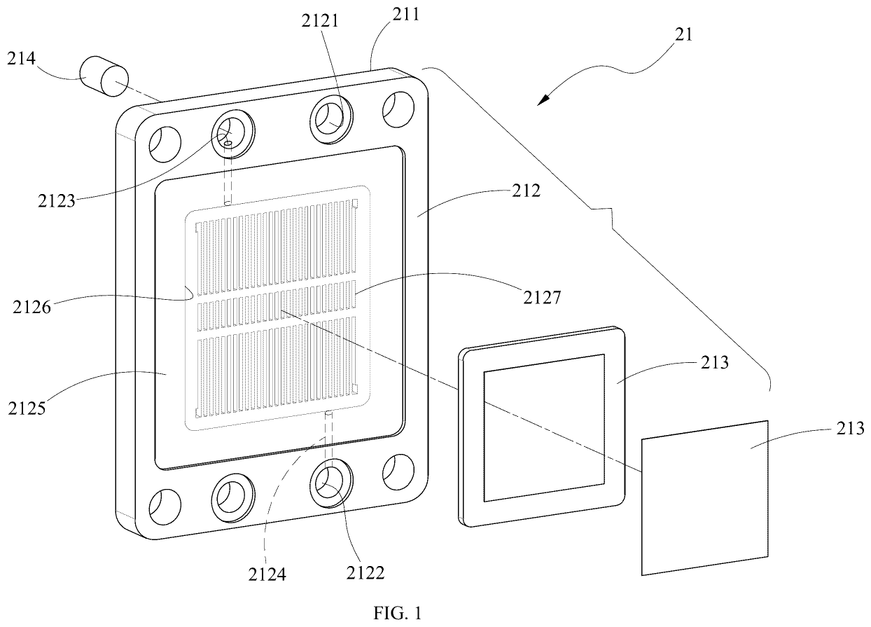

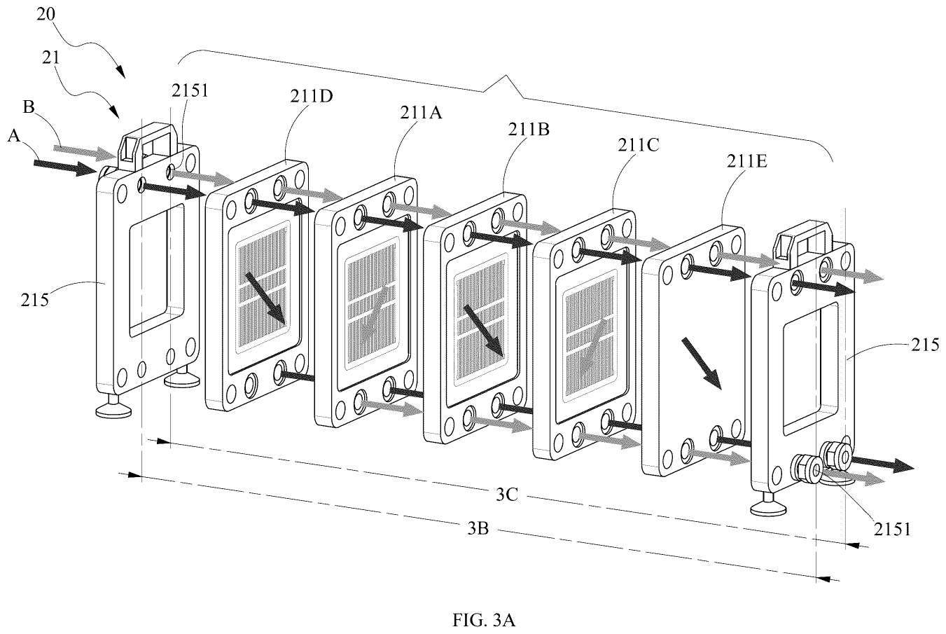

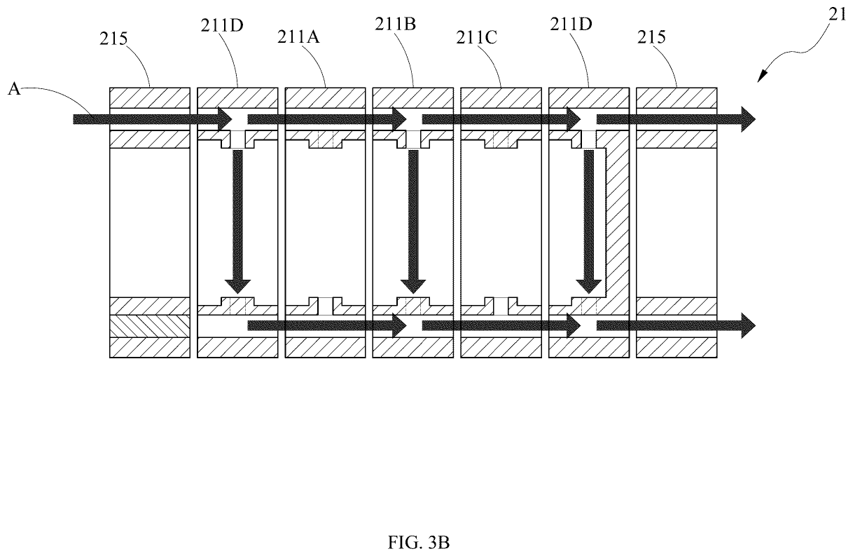

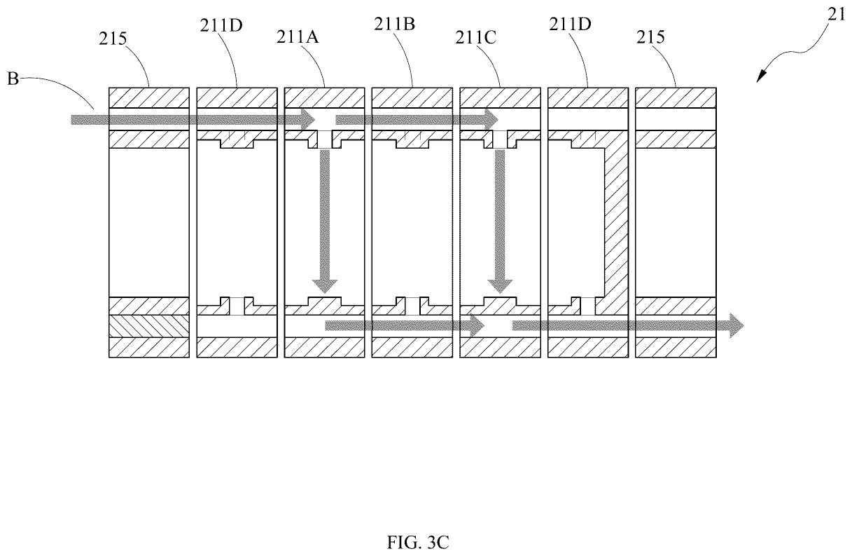

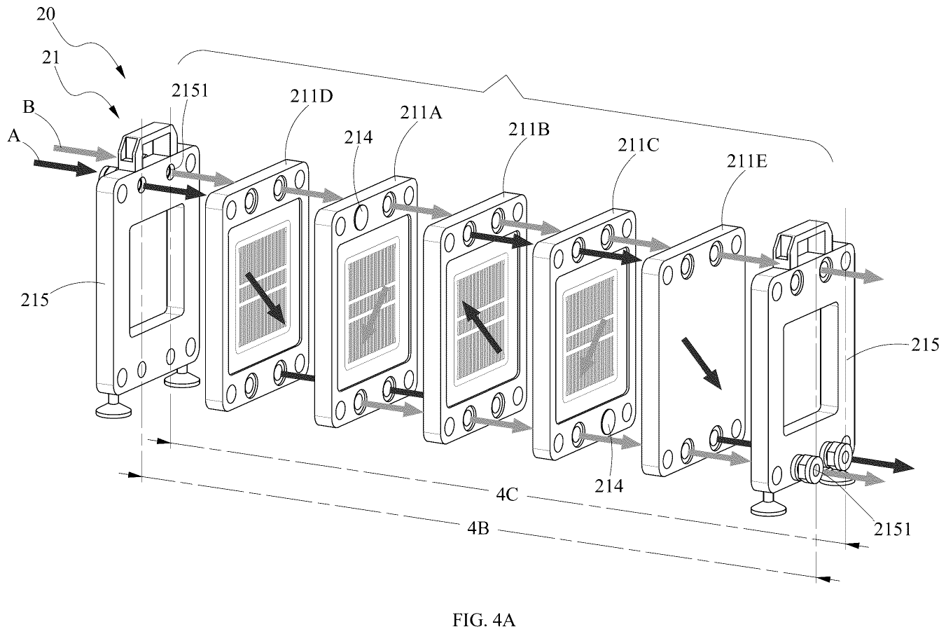

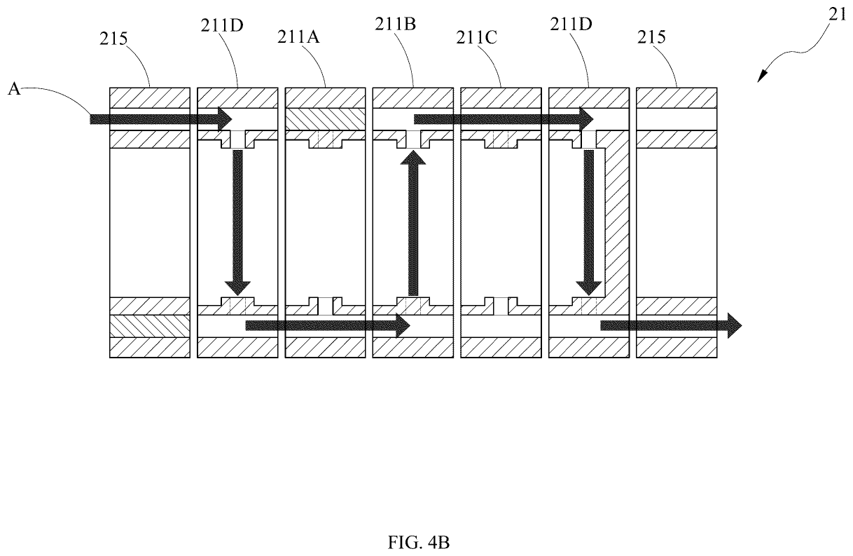

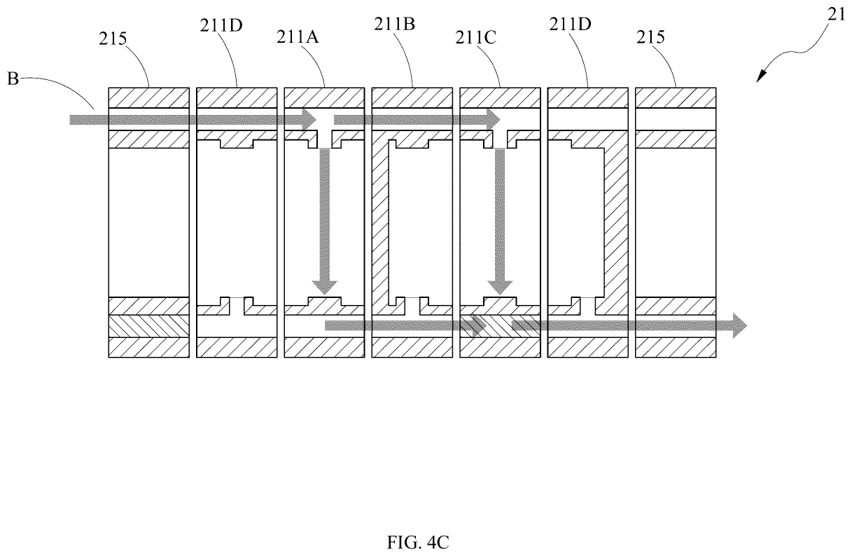

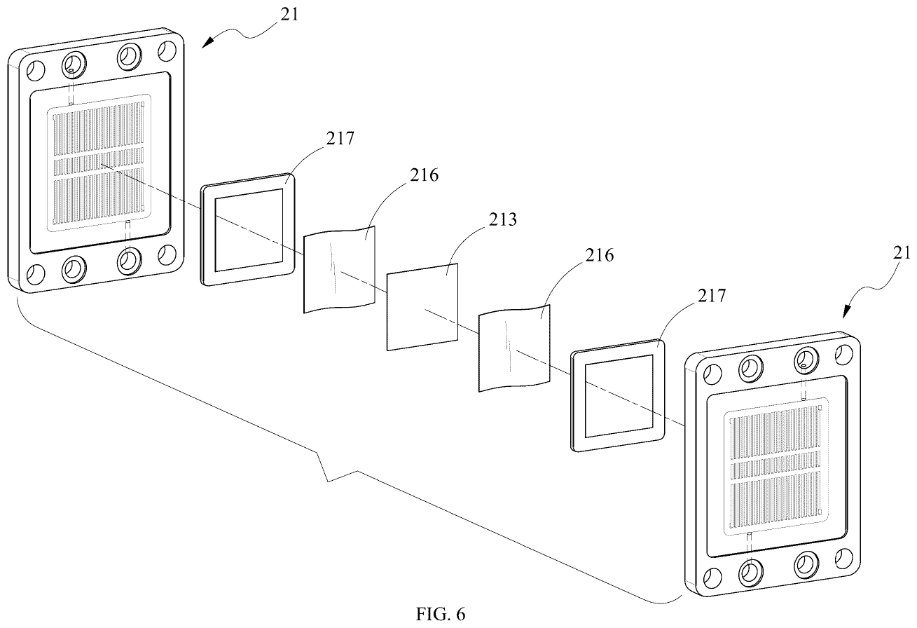

Referring to FIG. 1, FIG. 3A, FIG. 4A and FIG. 6, the purification equipment 20 comprises a membrane distillation module 21 comprising at least one membrane distillation plate 211, at least one distillation membrane 213 and a blocking element 214. The distillation membrane 213 is placed at one side of the membrane distillation plate 211 that the fluid A can be purified or concentrated by distillation from the distillation membrane 213 when go through the membrane distillation plate 211. Preferably, when more than two membrane distillation plates 211 is required, multiple distillation membranes 213 are arranged between two adjacent membrane distillation plate 211 respectively.

The distillation membrane 213 may be composed by one or more layers of hydrophobic and porous membranes. Wherein a material of the distillation membrane 213 can be Polystyrene (PS), Polyethylene (PE), Polyvinylidene fluoride (PVDF), Polyethersulfone (PES), Polytetrafluoroethylene (PTFE), Polypropylene (PP), or mixture thereof. Preferably. A thick of the distillation membrane 213 is between 10-80 um, a porosity of the distillation membrane 213 is between 30-90%, and an aperture of the distillation membrane 213 is between 0.1-0.8 um.

In the preferred embodiment, two fabrics 216 are respectively provided at two sides of the distillation membrane 213 to support the distillation membrane 213 and to protect the distillation membrane from being damaged. Preferably, the fabrics 216 can be a non-woven fibric, and a material of each fabric 216 can be polystyrene (PS), polyethylene (PE), polyamide (PA), polycarbonate (PC), polytetrafluoroethylene (PTFE), polypropylene (PP), or mixture thereof. A thick of the fabric 216 is between 0.2-1 mm, and an aperture of the fabric 216 is between 1-300 um.

Moreover, two frame 217 are applied to sandwich the distillation membrane 213 and the fabrics 216 by clamping at least part of the edge of the distillation membrane 213 and the fabrics 216. At the meantime, the frames 217 provide a structural rigidity to prevent the distillation membrane 213 and the fabrics 216 from being displaced or deformed as the fluid A is flowing in the purification equipment 20.

Preferably, a material of each frame 217 is polystyrene (PS), polyethylene (PE), polyamide (PA), polycarbonate (PC), polytetrafluoroethylene (PTFE) or polypropylene (PP) or mixture thereof. And a thickness of the frame 217 is between 0.2 and 1 millimeter (mm).

The membrane distillation plate comprises a baes plate 212 comprising two ends, an upper portion being adjacent to one of the two ends of the base plate, a lower portion being adjacent to the other end of the base plate. The baes plate 212 comprises two upper holes 2121, two lower holes 2122, an upper channel 2123, a lower channel 2124 and a distillation portion 2125. The two upper holes 2121 are spaced from each other and defined through the upper portion of the base plate 212, and two lower holes 2122 are spaced from each other and defined through the lower portion of the base plate 212. When multiple baes plates 212 are stacked with each other, the upper holes 2121 and the lower holes 2122 of the multiple base plates 212 are adjacently aligned and connected with each other, and the entire membrane distillation module 21 forms two upper fluid channels 218 and two lower fluid channels 219 for draining the fluid A or other liquids.

Preferably, a diameter of each upper hole 2121 and the diameter of each lower holes 2122 are the same.

The distillation portion 2125 is recessed in one side of the base plate 212, located between the upper portion and the lower portion, and is separated from the upper holes 2121 and the lower holds 2122. The distillation membrane 213 covers the distillation portion 2125 that a distillation space 2126 is formed between the distillation membrane 213 and the distillation portion 2125. Thus, the fluid A can flow in the distillation space 2126 and at least one part of the fluid A can be separated from the distillation space 2126 through the distillation membrane 213.

Preferably, the fluid A can be pure water, wastewater containing ammonia nitrogen, brine, sulfuric acid or seawater. More preferably, a concentration of the brine is between 0 and 22%, the concentration of the sulfuric acid is between 0 and 20%.

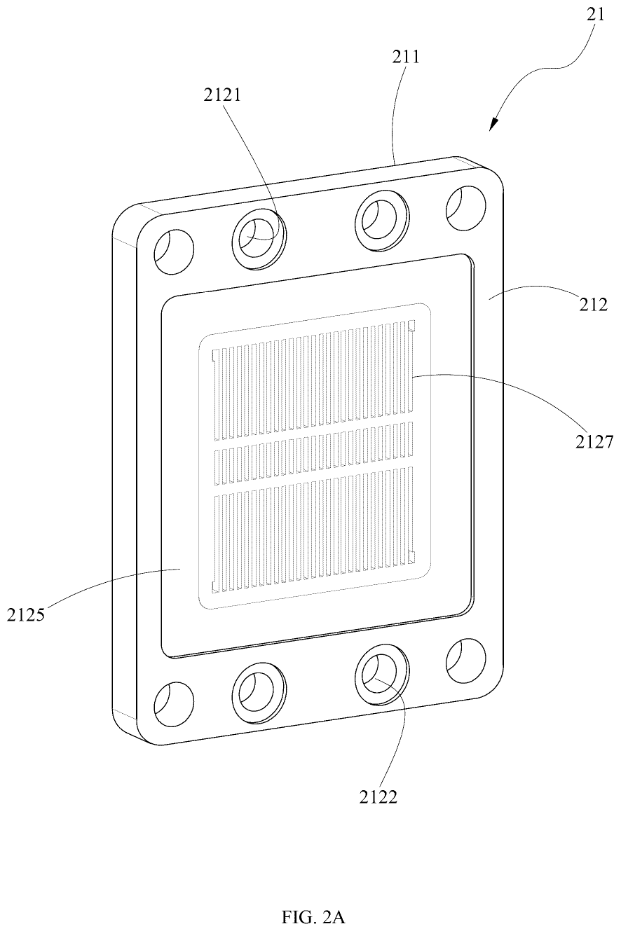

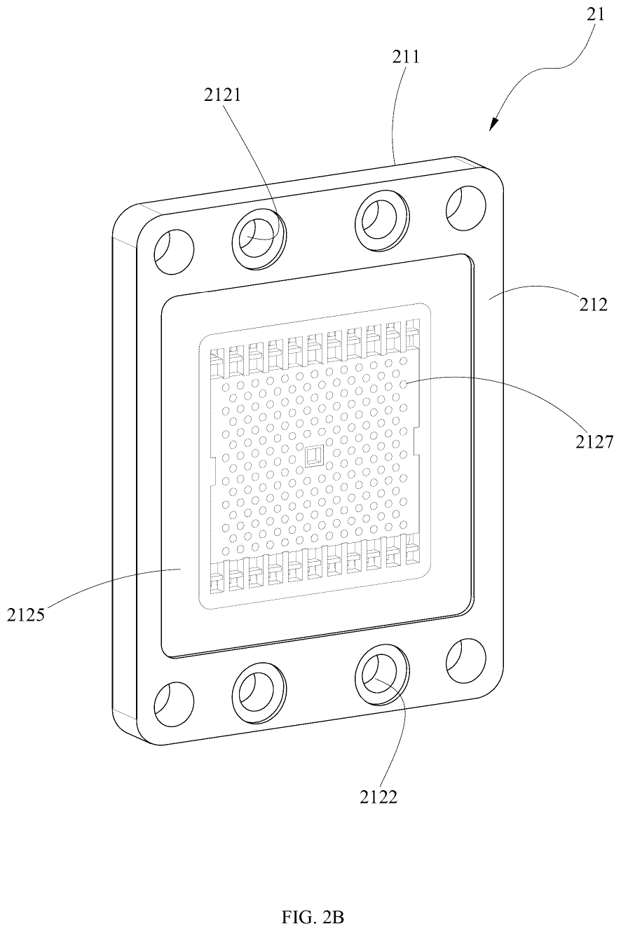

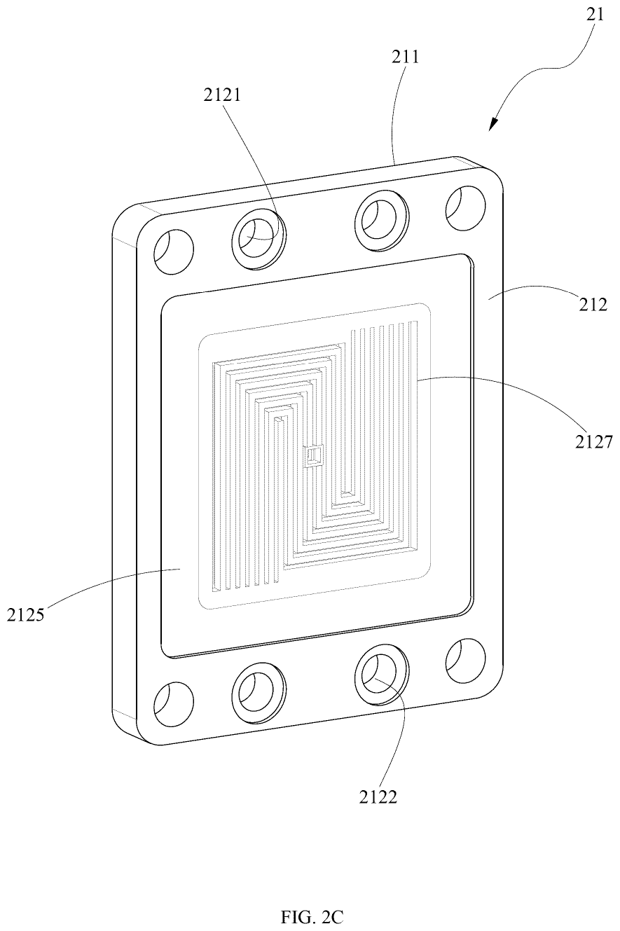

Referring to FIG. 2A to FIG. 2C, a difference from the above mentioned is that a guiding portion 2127 is disposed at the distillation portion 2125, and the distillation membrane 213 covers the distillation portion 2125 and the guiding portion 2127. In some embodiments, the guiding portion 2127 protrudes in the distillation space 2126 to guide the fluid A along a flowing direction.

In certain embodiment, two distillation portions 2125 are symmetrically recessed in two side of the base plate 212, respectively, and a guiding portion 2127 is penetrated through the base plate 212 to make the distillation portion 2125 become a hollow pattern. Two distillation membranes 213 respectively cover the distillation portions 2125 recessed in two side of the base plate 212 and the guiding portion 2127. The fluid A can communicate between the distillation spaces 2126 formed at two side of the base plate 212 and the guiding portion 2127, and the base plate 212 can increase the overall distillation capacity through the distillation membranes 213 located on two sides of the base plate 212.

As shown in FIG. 2A and 2B, the guiding portion 2127 can be multiple holes arranged in an array and defined through the bottom of distillation portion 2125. With reference to FIG. 2C, the guiding portion 2127 is multiple S-shaped long holes defined through the bottom of the distillation portion 2125, and the S-shaped long holes are arranged in parallel with each other. In addition, the guiding portion 2127 may multiple protrusions arranged in an array and protrudes from the surface of distillation portion 2125.

With the arrangement mentioned above, the distillation portion 2125 not only can assist the fluid A be guided in the distillation space 2126, the distillation portion 2125 also can support the distillation membranes 213 from being deformed or being displaced toward the distillation space 2126 to prevent the distillation membranes 213 from pressing the distillation space 2126 and affecting a purification efficiency of the fluid A.

The upper channel 2123 and the lower channel 2124 are disposed in the baes plate 212, wherein two ends of the upper channel 2123 are respectively connected to one of the upper holes 2121 and the distillation portion 2125 and/or the distillation space 2126; and two ends of the lower channel 2124 are respectively connected to one of the lower holes 2122 and the distillation portion 2125 and/or the distillation space 2126.

Worthy to mention is that only one upper hole 2121 in each base plate 212 is connected to the upper channel 2123, and one lower hole 2122 in each base plate 212 is connected to the lower channel 2124. Thus, one of the upper holes 2121, the upper channel 2123, the distillation portion 2125, one of lower holes 2122 and the lower channel 2124 are communicated with each other, while the other upper hole 2121 and the other lower hole 2122 are not only isolated from each other, but also are not connected to the distillation portion 2125.

For example, when the fluid A flowing in one of the upper fluid channels 218 passes through the upper hole 2121 connected to the upper channel 2123, at least one part of the fluid A can be separated and be guide into the distillation space 2126 from the upper channel 2123, the fluid A then can be guided to lower hole 2212 and the lower fluid channel 219 sequentially through the guiding portion 2127 and the lower channel 2134.

On the contrary, when the fluid A flows in one of the lower fluid channels 219, the fluid A can also be guided to the upper fluid channel 218 through the lower channel 2124, the distillation space 2126, the upper channel 2123 and the upper hole 2121 in sequence. In this way, when the fluid A enters the distillation space 2126 from one of the upper fluid channels 218 and/or the lower fluid channels 219, the fluid A can be purified from the distillation membrane 213 to achieve the effect of membrane distillation.

Preferably, the upper channel 2123 and the lower channel 2124 are diagonally connected to the distillation space 2126, which helps the fluid A can completely pass through the entire range of the distillation space 2126.

The blocking element 214 is applied to be selectively combined with one of the upper holes 2121 or the lower holes 2122, and to block the fluid A passing through the one of the upper holes 2121 or the lower holes 2122. For example, when the blocking element 214 is combined with one of the upper holes 2121, the fluid A may be blocked by the blocking element 214 that leads all the fluid A be guided to the distillation space 2126 from the upper channel 2123 which connected to the other unblocked upper holes 2121. Thus, the flowing direction of the fluid A in the membrane distillation module 21 can be generated in various patterns according to the selectively setting number of the blocking element 214.

Preferably, based on the flowing direction of the fluid A, the blocking element 214 is arranged in the upper holes 2121 or the lower holes 2122 of the base plate 212 which is adjacent to the other base plate 212 having the upper holes 2121 or the lower holes 2122 connected to the upper channel 2123 or the lower channel 2124. Thus, all the fluid A can directly flowing into the distillation space 2126 when the fluid A is blocked by the blocking element 214.

With the selective combination of the blocking element 214, the flowing direction and a membrane distillation duration of the fluid A can be manipulated subject to the membrane distillation module 21 used. The reason is that all the fluid A is guided into the distillation space 2126 when the blocking element 214 is applied, the membrane distillation duration will be longer than the fluid A flowing into the membrane distillation module 21 without blocking element 214.

Wherein, the blocking element 214 is not limited to being a separate part from the base plate 212. For example, the base plate 212 can be fabricated with or without the blocking element 214 when during production. In other words, one of the upper holes 2121 or the lower holes 2122 is closed to define the blocking element 214 within the base plate 212 in one piece. In this way, the membrane distillation module can just replace one of the base plates 212 with or without the blocking element 214 when in use, and a user is no needed to worry that the blocking element 214 is difficult to store due to its small size or a complex process by repeatedly removing the base plate 212 to assemble the blocking element 214.

It is worthily to notice that when all the fluid A enters the distillation space 2126, the guiding portion 2127 can effectively guide a suddenly large inflow of the fluid A in the distillation space 2126 to prevent the fluid A from jam and causing the distillation membrane 213 be pressed or damaged.

With reference to FIG. 3A to FIG. 4B and Table 1, the flowing directions of the fluid A, the flow rates of the fluid A, and the production rate of the purified fluid C are shown as the blocking element 214 is applied or not applied in the membrane distillation system. Wherein, two fixed elements 215 are respectively provided at two ends of a stacking direction of the membrane distillation module 21 and are assembles with at least one/stacked-like membrane distillation plate 211. It is not limited to the method of assembling the fixed element 215 and the membrane distillation plate 211. In the preferred embodiment, a screw rod is inserted into the two fixed elements 215 and the membrane plate 211 in sequence, then a bolt is screwed with one end of the screw rod to easily complete the assembly of the membrane distillation module 21.

Preferably, the fixed element 215 is plate like, comprises at least four connecting holes 2151 which is aligned with the two upper holes 2121 and two lower holes 2122, respectively. Each connecting holes 2151 of the fixed plate 215 may be selectively used as an inlet to introduce the fluid A or a condensate B, or as an outlet to discharge the purified fluid C or the waste fluid.

### Comparative Example

Two single-sided membrane distillation plates 211D are staked with each other as the membrane distillation module 21 to become a comparative example. Wherein, each single-sided membrane distillation plate 211D has one distillation portion 2125, and two single-sided membrane distillation plates 211D are staked with each other on the side including the distillation portion 2125, and one distillation membrane 213 is placed between the two distillation portion 2125. A total volume of the fluid A is 10 liters (L), and a working temperature of the membrane distillation module 21 is between 60 to 65 degrees Celsius (C). The fluid A is a water which is flowing into the membrane distillation module 21 from one connecting hole 2151 of the fixed element 215 placed at on end of the stacking direction. The connecting hole 2151 is aligned with the upper fluid channels 218 which is formed from the upper holes 2121 communicated with each other. Thus, one part of the fluid A may be guided into the distillation portion 2125 through the upper channel 2123, then be guided into the lower hole 2122 for discharge since the lower channel 2134, and the other part of the fluid A is flowing through the upper fluid channels 218. The condensate B is the water with a temperature about 28° C. The condensate B is introduced into the other upper fluid channels 218 from the one fixed element 215 placed at the end same as the fluid A, and directly flows into the distillation portion 2125 of the other fixed plate 215 at the other end of the stacking direction. It can be seen from the Table. 1, since there is only one the distillation membrane 213, the flow rate of the fluid A in the comparative example is 0.75 liters per minute (l/min), and the membrane distillation duration of the fluid A is 4 hours, the total volume of the purified liquid is between 140 to 190 milliliters (mL).

### Embodiment 1

With reference to FIG. 3A and FIG. 3B, in this embodiment, the total volume, the working temperature, and the inlets of the fluid A and the condensate B are all the same as those in the comparative example mentioned above.

Wherein, there are five membrane distillation plates 211, and two of five membrane distillation plates 211 are single-sided membrane distillation plates 211D, which are placed at two ends of the stacking direction of membrane distillation module 21 respectively. The rest of membrane distillation plates 211, with distillation portion 2125 formed at the two sides, are defined as the first membrane distillation plate 211A, the second membrane distillation plate 211B, and the third membrane distillation plate 211C sequentially comparing to the flowing direction. Wherein, each membrane distillation plate 211 is not provided with the blocking element 214, and four distillation membranes 213 are respectively placed between two adjacent membrane distillation plates 211.

Wherein, the two upper channels 2123 between two adjacent membrane distillation plates 211 are arranged in an alternate way, that is to say, when one of the upper holes 2121 of the first membrane distillation plate 211A is connected to the upper channel 2123, the upper channel 2123 of the second membrane distillation plate 211B then is configured to be connected with the upper hole 2121 which is not aligned with the upper hole 2121 connected with the upper channel 2123 in the first membrane distillation plate 211A.

Wherein, two lower channels 2124 between two adjacent membrane distillation plate 211 are arranged in an alternate way, that is to say, when one of the lower holes 2122 of the first membrane distillation plate 211A is connected to the lower channel 2124, the lower channel 2124 of the second membrane distillation plate 211B then is configured to be connected with the lower hole 2124 which is not aligned with the one lower hole 2122 connected to the lower channel 2124 in the first membrane distillation plate 211A.

In this way, when the fluid A is introduced into one of the upper fluid 24 channels 218 from the fixed element 215 placed at one side of the membrane distillation module 21, at least one part of the fluid A may be guided into the distillation portion 2125 when passing through the single-sided membrane distillation plates 211D. Then the fluid A is guided to the lower fluid channels 219 through the lower hole 2122, and flows to the second membrane distillation plate 211B. The other part of the fluid A is guided to the upper hole 2121 of the first membrane distillation plate 211A without flowing into the distillation portion 2125, and enters to the second membrane distillation plate 211B directly.

Along the flowing direction, due to the arrangement of the upper channel 2123 in the second membrane distillation plate 211B and the third membrane distillation plate 211C is same as the arrangement of the upper channel 2123 in one of the single-sided membrane distillation plates 211D and the first membrane distillation plate 211A. The arrangement of the upper channel 2123 in the third membrane distillation plate 211C is same as the arrangement of the upper channel 2123 in the other single-sided membrane distillation plates 211D, the details of subsequent flowing of the fluid A in the membrane distillation module method will not be described here.

On the other hand, the condensate B is introduced into the other upper flow channel 218 from the one end of the stacking direction, which is same as the fluid A. Instead of flowing into the distillation portion 2125 when passing through the single-sided membrane distillation plates 211D near said fixed plate 215, the condensate B will directly enter to the first membrane distillation plate 211A. At least one part of the condensate B may be guided into the distillation portion 2125 when passing through the first membrane distillation plate 211A, then be guided in the lower fluid channels 219 through the lower hole 2122 to the second membrane distillation plate 211B. Similarly, since the arrangement relationship of each membrane distillation plate are mentioned above, the subsequent flowing direction of the condensate B will not be described again here.

With a staggered arrangement between each upper channel 2123 and 4 lower channel 2134, the fluid A and the condensate B have flowing directions independently in the membrane distillation module 21. Then forming the temperature difference when the fluid A and the condensate B flow through the two adjacent distillation portion 2125 respectively by controlling the temperatures of the fluid A and the condensate B. thus, the fluid A may be distilled and leave the distillation space 2126 through the distillation membrane 213 to achieve the function of filter, concentrate and purify the fluid A.

Referring to the Table. 1, because the number of the distillation membrane 213 is four, and the flowing direction of the fluid A includes at least two paths, the flow rate of the fluid A in the Embodiment 1 is 3 liters per minute (l/min), and the membrane distillation duration of the fluid A is 1 hour, the total volume of the purified liquid is between 400 to 430 milliliters (mL).

As the result of the membrane distillation module 21 in Embodiment 1,under a condition with multiple distillation membranes 213 without blocking element 214, not only the membrane distillation duration of the Embodiment 1 is significantly shorter than comparative example, even the total volume of the purified liquid is 2 to 3times greater than the comparative example. The membrane distillation module 21 provides a membrane distillation method with a short time and a short path for purifying the fluid A, which is suitable for the membrane distillation system that loads a large volume of the fluid A at one time, such as the membrane distillation system in general industrial wastewater or civilian wastewater.

### Embodiment 2

With reference to FIG. 4A and FIG. 4B, in this embodiment, the total volume, the working temperature, and the inlets of the fluid A and the condensate B are all the same as those in the comparative example and Embodiment 1 mentioned above.

Wherein, there are five membrane distillation plates 211, and two of five membrane distillation plates 211 are single-sided membrane distillation plates 211D, which are placed at two ends of membrane distillation module 21 separately. The rest of membrane distillation plates 211, with two distillation portions 2125 formed at the two sides, are defined as the first membrane distillation plate 211A, the second membrane distillation plate 211B, and the third membrane distillation plate 211C sequentially comparing to the flowing direction. Wherein, the arrangement relationship of each upper channel 2123 and each lower channel 2124 is same as the Embodiment 1 that will not be repeated here. The difference between the Embodiment 2 and Embodiment 1 is comprising at least one blocking element 214 which is placed corresponding to the flowing direction of the solution A.

In the present embodiment, two blocking elements 214 are respectively combined with one upper hole 2121 of the first membrane distillation plate 211A and one lower hole 2122 of the third membrane distillation plate 211C. When the fluid A is introduced into one of the upper fluid channels 218 from the fixed element 215 placed at one side of the membrane distillation module 21, because the blocking elements 214 blocks the one upper hole 2121 of the first membrane distillation plate 211A, all of the fluid A is guided into the distillation portion 2125 when flowing to the single-sided membrane distillation plates 211D. And all of the fluid A then be guided into the lower fluid channels 219 through the lower hole 2122 and enters into the second membrane distillation plate 211B. Similarly, because the blocking elements 214 blocks the one lower hole 2121 of the third membrane distillation plate 211C, when the fluid A enters the second membrane distillation plate 211B, all of the fluid A is guided into the distillation portion 2125 from the lower channel 2124 of the second membrane distillation plate 211B and leave the distillation portion 2125 from the upper channels 2123.

In the other hand, since the flowing direction of the condensate B is not affected by the blocking element 214, the flowing direction of the condensate B in the present invention is same as Embodiment 1 that will not be described again here.

Referring to the Table. 1, although the number of the distillation membrane 213 same as Embodiment 1 is four, but the flowing direction of the fluid A is be manipulated by the arrangement of the blocking element 214 that the flowing direction of the fluid A exhibits only one path in the membrane distillation module 21. And the flow rate of the fluid A in the Embodiment 2 is 3 liters per minute (l/min), the membrane distillation duration of the fluid A is 1 hour, the total volume of the purified liquid is between 590 to 630 milliliters (mL).

As the result of the membrane distillation module 21 in Embodiment 2, under the condition with multiple distillation membranes 213 with the blocking element 214, although the membrane distillation duration of the Embodiment 2 is same as Embodiment 1, but the total volume of the purified liquid is 3 to 4 times greater than the Embodiment 1. The membrane distillation module 21 provides a membrane distillation method with a long path for purifying the fluid A, which is suitable for the membrane distillation system with high cleanliness filtration requirements, such as heavy metal filtration or chemical drug filtration.

### Embodiment 3

With reference to FIG. 4A to FIG. 4B, in this embodiment, the total volume, the working temperature, and the inlets of the fluid A and the condensate B are all the same as those in the comparative example, Embodiment 1 and Embodiment 2 mentioned above. The arrangement of the membrane distillation plates 211 and the blocking element 214 of the Embodiment 3 is also same as the Embodiment 2 that will not be described again here. Wherein, the fluid A is a sulfuric acid with 5% concentration. The flowing direction of fluid A and condensate B in the present embodiment is same as the flowing direction of fluid A and condensate B in the Embodiment 2.

Referring to the Table. 1, the flow rate of the fluid A in the Embodiment 3 is 0.75 liters per minute (l/min), the membrane distillation duration of the fluid A is 4 hours, the total volume of the purified liquid is between 590 to 630 milliliters (mL). Worthily to notice is that, a concentration of fluid A was increased from 5% to 20%, which can be confirmed that the replaceable membrane distillation module provided by the present invention can achieve an excellent membrane distillation effect.

TABLE 1

| | Compar- | | | |
|---|---|---|---|---|
| | ative | Embodi- | Embodi- | Embodi- |
| | example | ment 1 | ment 2 | ment 3 |
| Number of distillation | 1 | 4 | 4 | 4 |
| membranes | | | | |
| Number of blocking | 0 | 0 | 2 | 2 |
| element | | | | |
| Type of fluid A | water | water | water | sulfuric |
| | | | | acid |
| Membrane distillation | 4 | 1 | 4 | 4 |
| duration (H) | | | | |
| Temperture of fluid A | 60-90 | 60-90 | 60-90 | 60-90 |
| (° C.) | | | | |
| Total volume of the fluid | 10 | 10 | 10 | 10 |
| A (L) | | | | |
| Flow rate of the fluid A | 0.75 | 3 | 0.75 | 0.75 |
| (L/min) | | | | |
| Total volume of the | 160-220 | 400-430 | 590-630 | 590-630 |
| purified liquid (mL) | | | | |

Furthermore, the present invention additionally provides an embodiment 4, which applied the condition of comparative example for membrane distillation. The difference from the previous embodiments is that the fluid A contains a solid material with a volume concentration of about 40%, which is applied to test the membrane distillation efficiency of the distillation membrane 213.

The membrane distillation duration of the fluid A in the embodiment 4 is 5 hours, and total volume of the purified liquid is between 40 to 100 milliliters (mL). wherein, a conductivity value of the condensate B is changed from 3.6 μS/cm to 5.7 μS/cm after the membrane distillation, which means that the membrane distillation module 21 the present invention provided can maintain a stable quality of the purified liquid after membrane distillation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A membrane distillation plate comprising:
a base plate comprising two ends, an upper portion being adjacent to one of the two ends of the base plate, a lower portion being adjacent to the other end of the base plate, two upper holes spaced from each other and defined through the upper portion, and two lower holes are spaced from each other and defined through the lower portion;
a distillation portion recessed in at least one side of the base plate, located between the upper portion and the lower portion, and separated from the upper holes and the lower holes;
an upper channel disposed in the baes plate, wherein two ends of the upper channel are respectively connected to one of the upper holes and the distillation portion;
a lower channel disposed in the baes plate, wherein two ends of the lower channel are respectively connected to one of the lower holes and the distillation portion.

2. The membrane distillation plate as claimed in claim 1, further comprising a blocking element which is selectively combined with one of the upper holes or the lower holes.

3. The membrane distillation plate as claimed in claim 2, wherein two distillation portions are symmetrically recessed in two side of the base plate, respectively.

4. The membrane distillation plate as claimed in claim 2, wherein the upper channel and the lower channel are diagonally connected to the distillation portion.

5. The membrane distillation plate as claimed in claim 3, wherein the upper channel and the lower channel are diagonally connected to the distillation portion.

6. The membrane distillation plate as claimed in claim 2, wherein the blocking element is formed with the base plate in one piece.

7. The membrane distillation plate as claimed in claim 5, wherein the blocking element is formed with the base plate in one piece.

8. The membrane distillation plate as claimed in claim 2, further comprising a guiding portion disposed at the distillation portion, wherein the guiding portion is defined through the base plate that makes the distillation portion become a hollow pattern.

9. The membrane distillation plate as claimed in claim 7, further comprising a guiding portion disposed at the distillation portion, wherein the guiding portion is defined through the base plate that makes the distillation portion become a hollow pattern.

10. The membrane distillation plate as claimed in claim 2, further comprising a guiding portion disposed at the distillation portion, wherein the guiding portion is a protrusion protruding from the surface of distillation portion.

11. The membrane distillation plate as claimed in claim 7, further comprising a guiding portion disposed at the distillation portion, wherein the guiding portion is a protrusion protruding from the surface of distillation portion.

12. The membrane distillation plate as claimed in claim 9, further comprising at least two distillation membranes which cover the distillation portions respectively, two distillation space formed between the distillation membranes and the distillation portions.

13. The membrane distillation plate as claimed in claim 10, further comprising at least one distillation membrane which covers the distillation portion, a distillation space formed between the distillation membrane and the distillation portion.

14. The membrane distillation plate as claimed in claim 12, wherein:
a material of the at least two distillation membranes is Polystyrene (PS), Polyethylene (PE), Polyvinylidene fluoride (PVDF), Polyethersulfone (PES), Polytetrafluoroethylene (PTFE), or Polypropylene (PP); a thick of the distillation membrane is between 10-80 um, a porosity of the distillation membrane is between 30-90%, and an aperture of the distillation membrane is between 0.1-0.8 um;
two fabrics are provided at two sides of each one of the distillation membranes, wherein each fabric is a non-woven fibric, a material of the fabric is polystyrene (PS), polyethylene (PE), polyamide (PA), polycarbonate (PC), polytetrafluoroethylene (PTFE), polypropylene (PP), or mixture thereof; a thick of the fabric is between 0.2-1 mm, and an aperture of the fabric is between 1-300 um; and
two frames sandwiching at least part of the at least two distillation membranes and at least part of the two fabrics, and a material of each frame is polystyrene (PS), polyethylene (PE), polyamide (PA), polycarbonate (PC), polytetrafluoroethylene (PTFE) or polypropylene (PP) or mixture thereof, and a thickness of the frame 217 is between 0.2 and 1 millimeter (mm).

15. A replaceable membrane distillation module comprising:
at least two membrane distillation plates according to claims 1 wherein:
when the membrane distillation plates are stacked with each other, two upper fluid channels and two lower fluid channels are defined when each adjacent upper hole and each adjacent the lower hole are connected to each other.

16. The replaceable membrane distillation module as claimed in claim 15, further comprising a blocking element which is selectively combined with one of the upper holes or the lower holes, and the blocking element blocks one of the upper fluid channels or one of the lower fluid channels selectively.

17. The replaceable membrane distillation module as claimed in claim 16, wherein:
the upper channels are arranged in staggered along a stacking direction defined by the stacked membrane distillation plates;
the lower channels are arranged in staggered along a stacking direction defined by the stacked membrane distillation plates; and
the upper channel and the lower channel between two adjacent membrane distillation plate are isolated to each other.

18. The replaceable membrane distillation module as claimed in claim 17, wherein:
the blocking element is combined with one the upper hole in one of the at least two membrane distillation plates which is aligned with the upper hole connected to the upper channel in an adjacent membrane distillation plate.

19. The replaceable membrane distillation module as claimed in claim 17, wherein:
the blocking element is combined with one the lower hole in one of the at least one membrane distillation plates which is aligned with the lower hole connected to the lower channel in an adjacent membrane distillation plate.

20. The replaceable membrane distillation module as claimed in claim 17, wherein: two membrane distillation plates are provided and each membrane distillation plate has one distillation portion at one side of the membrane distillation plate staked with each other at the side having the distillation portion.

21. The replaceable membrane distillation module as claimed in claim 20, wherein:
three membrane distillation plates are provided, and each membrane distillation plate has two distillation portions formed at two side of the membrane distillation plate, respectively,
the three membrane distillation plates each with two distillation portions are placed between the two membrane distillation plates each with one distillation portion, and the membrane distillation plates are staked with each other.

22. The replaceable membrane distillation module as claimed in claim 17 further comprising at least one distillation membrane which is placed between the distillation portions on adjacent two membrane distillation plates, and covers the two distillation portions the adjacent two membrane distillation plates, a distillation space formed between each one the at least one distillation membrane and a corresponding one of the distillation portions.
